(19) United States
(12) Patent Application Publication
(10) Pub. No.: US 2008/0133533 A1
(43) Pub. Date: Jun. 5, 2008

(54) Migrating Credentials to Unified Identity Management Systems

(76) Inventors: Krishna Ganugapati, Redmond, WA (US); Manuel Vellon, Bellevue, WA (US)

Correspondence Address: WHITAKER LAW GROUP, 755 WINSLOW WAY EAST, SUITE 304, BAINBRIDGE ISLAND, WA, 98110, US

(21) Appl. No.: 11/946,834

(22) Filed: Nov. 28, 2007

Related U.S. Application Data
(60) Provisional application No. 60/867,562, filed on Nov. 28, 2006.

(51) Int. Cl. G06F 17/30

(52) U.S. Cl. 707/9; 707/E17.031

(57) ABSTRACT

Credentials are migrated into a unified identity management system which maintains existing mappings by associating the migrated credentials with existing directory service object instances. The schema of the directory service may or may not be modified.

### STATEMENT OF RELATED APPLICATIONS

This application claims priority to copending provisional application titled, “Migrating Credentials to Unified Identity Management Systems,” Ser. No. 60/867,562, filed on Nov. 28, 2006.

### SUMMARY OF THE INVENTION WITH BACKGROUND INFORMATION

This summary is provided to introduce a selection of concepts in a simplified form that are further described below in the detailed description. This summary is not intended to identify key feature or essential features of the claimed subject matter, nor is it intended to be used to limit the scope of the claimed subject matter.

The use of multiple computer operating systems is common in modern corporations. A mixture of Microsoft Windows®, Sun Solaris®, Apple OSX® and various different versions of Unix and Linux are commonplace. Each of these operating systems provides its own mechanisms for maintaining username and password information (“credentials”). This results in considerable administrative overhead when users need to be given access to computers, have access taken away or have their credentials modified (for examples, to change passwords). System administrators may need to perform these operations on multiple operating systems and on multiple machines.

A common scenario (Scenario 1) is to have Microsoft Windows-based computers using Active Directory® by the Microsoft corporation (“AD”) for authentication but to have all Unix, Linux and Macintosh computers using local authentication. In this scenario, the Windows computers may authenticate with AD, but each of the other systems has its own, local, username/password database or table. Administrative changes have to be made once to AD and then N times for each of the other systems. Another common scenario (Scenario 2) is to use AD for Windows-based systems and then to use one or more Network Information Service (“NIS”) servers to provide authentication for Unix, Linux and Macintosh systems.

Modern operating systems support mechanisms for access control to assure that only authenticated users have access to protected resources. A user without a valid username and password may not have access to some or all resources (files, databases, devices, etc.). Even an authenticated user is typically restricted to accessing specific resources. Different operating systems use different techniques for specifying access controls based on user credentials. Ultimately, what they do is to specify which users have access to what resources.

All operating systems start out by converting user names into more useful representations. User names are not a good basis for access control for several reasons. First, dealing with variable length names imposes computational complexity in processing that should be fast. Second, users might want to change their names (for example, due to change in marital status) and, yet, keep access to their resources. Operating systems typically map user names into numerical representations. Windows® maps usernames into security identifiers (“SIDs”); Unix and Unix-variants map usernames into user ids (“UIDs”) and group ids (“GIDs”). These operating systems then base access control on these numerical representations. In the first scenario described above, each Unix, Linux and Macintosh system is independent of other identity management systems and performs its own name-to-UID/GID mapping. In the second scenario, each NIS server provides name-to-UID/GID mapping to its associated computers, though these mappings can be different between the NIS servers.

A mapping may be understood as a table that converts a username into a numerical representation: M(name)-->numerical identifier. In both scenarios described, there are multiple mappings: M₁, M₂, . . . Mₙ. In the first scenario, AD has a mapping and each Unix, Linux and Macintosh computer has its own mapping. In the second scenario, AD has a mapping and then each NIS server has a mapping.

The mappings utilized by AD are frequently supported by a directory service (“DS”). Directory services (DS'es) are used by organizations to store and organize information about users and computer resources distributed throughout their networks. This information is represented to users of the directory service as nodes on a hierarchy. Each node is an instance of an object class which itself is a collection of attributes. An object class is a template that lists a collection of attributes and their respective types. The schema of the DS is the definition of the object classes and associated attributes. Many modern directory services, such as AD, are based on the Lightweight Directory Access Protocol (LDAP). LDAP provides a hierarchical storage model to maintain information about users, computers and other entities.

By way of example, a user may be represented in a DS as an instance of the object class “user.” This object class lists a collection of attributes that describe a user, such as “sn” which holds the surname of the user and “mobile” which holds the primary mobile phone number of the user. Each type of resource, such as “user” or “computer,” is represented in the DS as an instance of an object class.

DS'es are used by software applications for a variety of purposes. Frequently, DS'es are used for user authentication purposes. When a user enters a username and password into an application, the application may communicate with the DS to assure that the user's password is correct and that the user has sufficient privileges to run the application.

To store additional information in a DS, such as the mappings maintained by NIS or an Unix/Linux computer when such are added to a DS utilized by AD, may require modifying the schema by adding new object classes with new attributes and/or attribute sets or by modifying existing object classes through the addition and/or modification of the attributes of such existing object classes. DS administrators may be reluctant to make schema modifications or to allow any other changes to be made to a DS that might affect the use and integrity of important directory service objects. There are several reasons for this reluctance. Schema modifications are frequently difficult to “undo” if anything goes wrong during the modification process. Poorly designed modifications can also impact DS performance. DS administrators might also be reluctant to allow applications to modify important data, such as may be found in “user” object instances. Software defects might accidentally result in data corruption that could severely impact system operations.

Migration to a unified identity management system (“IMS”) supported by one DS may simplify and allow central management of users and credentials. Migration to a unified IMS supported by one DS may be complicated by a desire to avoid having to unnecessarily change either i) the directory service (“DS”) which may continue to support an existing mapping service, other services, and a new IMS or ii) legacy computers and applications and processes to instruct such machines and processes to use the new IMS instead of the legacy system. If existing mappings are not preserved, users may lose access to resources that were previously available or, worse, if a user's name is inadvertently mapped to a numerical representation previously used by another user, the user might gain improper access to a resource that was previously inaccessible. If changes to a DS are made without sufficient knowledge of all application and process dependencies, then the changes may cause application and process failures.

The art has thus not demonstrated a satisfactory method to migrate credentials to a unified IMS with minimal changes to the DS supporting the unified IMS and with minimal changes to the legacy applications and processes which rely upon the legacy credential mappings.

Generally stated, this disclosure describes a method and technique for migrating credentials into a unified IMS which maintains existing mappings. The disclosed invention is directed to variations of a method for migrating non-native credentials into an IMS by associating the non-native credentials with existing DS object instances without the addition of attributes directly to the DS object classes. The variations involve creating an “Application Partition” (defined further herein). Nodes created in the Application Partition are referred to herein as “Cell Nodes.” One variation creates Cell Nodes as instances of existing object classes in the Application Partition; the certain of the mapping information is stored in the attributes of the new instances of the existing object classes. The schema of the DS in this variation is not modified. Another variation involves creating new object classes with attributes tailored to store the mapping information and creating Cell Nodes as instances of the new object classes in the Application Partition; certain of the mapping information is stored in the attributes of the new instances of the new object classes. The schema of the DS in this variation is modified.

### BRIEF DESCRIPTION OF THE DRAWINGS

FIG. 1 is an example of a typical LDAP data hierarchy such as may be maintained by AD.

FIG. 2 is a functional block diagram of exemplary computing devices and some data structures and/or components thereof, prior to modification according to this disclosure.

FIG. 3 is a functional block diagram of exemplary computing devices and some data structures and/or components thereof, after modification according to this disclosure.

FIG. 4 is an operational flow diagram generally illustrating steps consistent with certain aspects of the invention.

FIG. 5 is an operational flow diagram generally illustrating steps consistent with certain aspects of the invention.

FIG. 6 is an operational flow diagram generally illustrating steps consistent with certain aspects of the invention.

FIG. 7 is an operational flow diagram generally illustrating steps consistent with certain aspects of the invention.

FIG. 8 is a functional block diagram of an exemplary computing devices and some data structures and/or components thereof.

### DETAILED DESCRIPTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims. Certain of the figures are labeled with terms associated with specific software applications or categories of software applications. The labels and the following discussion use these terms and related terms as examples and not as limitations. Equivalent functions may be provided by other software applications operating on general and/or specialty purpose devices. Thus, references in this document to a browser, a webserver, a directory service, or a database should be understood to describe any software application providing similar functions, operating on suitable hardware for such software application, and provided with suitable communication facilities. References to a “network” shall be understood to describe any suitable network capable of providing communication between the other components, such as but not limited to the Internet. The components depicted in the figures represent function groups; it should be understood that such function groupings need not exist as discrete hardware devices or software applications and that the functions described as occurring within, comprising, or being provided by a grouping may be provided within or by common or separate physical and/or logical hardware devices and software applications. The components within and comprising any of the function groupings may be regrouped in other combinations and certain of the functions and/or steps may be omitted or re-ordered without deviating from the spirit of the disclosed invention.

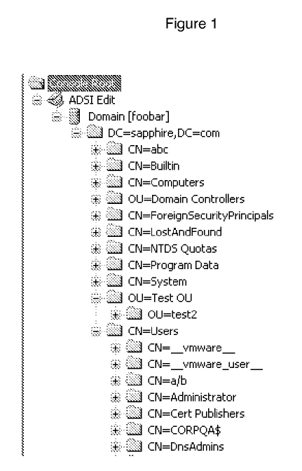

FIG. 1 is an example of a typical LDAP data hierarchy such as may be maintained by AD. Depicted in this drawing is a “domain,” [foobar]. Below the domain is a folder with two “DC” labels for “domain component,” the domain components being, in this example, “sapphire” and “com.” Below this folder are a series of folders which are either labeled “CN” for “common name” or “OU” for “organizational unit.” The node “CN=Computers” may hold nodes below it which maintain information about computer resources; the node “CN=Users” may hold nodes below it which maintain information about users, such as encrypted passwords. The node “CN=Program Data” may be used by applications and processes to maintain application and/or process specific information. This part of the hierarchical tree structure is referred to herein as the “Application Partition;” however, other node or nodes may be chosen or created to maintain application- or process-specific information and to serve as the Application Partition provided such node or nodes may be used by applications and processes to maintain application and/or process specific information. In an embodiment, the Application Partition may comprise a node or nodes which reside in the same part of the directory hierarchy as the object instances which the Application Partition nodes extend or add data to; in such an embodiment, the Application Partition may not be a specific branch within the DS hierarchy, but may comprise multiple branches and/or specific leaf nodes which are present throughout the DS tree structure.

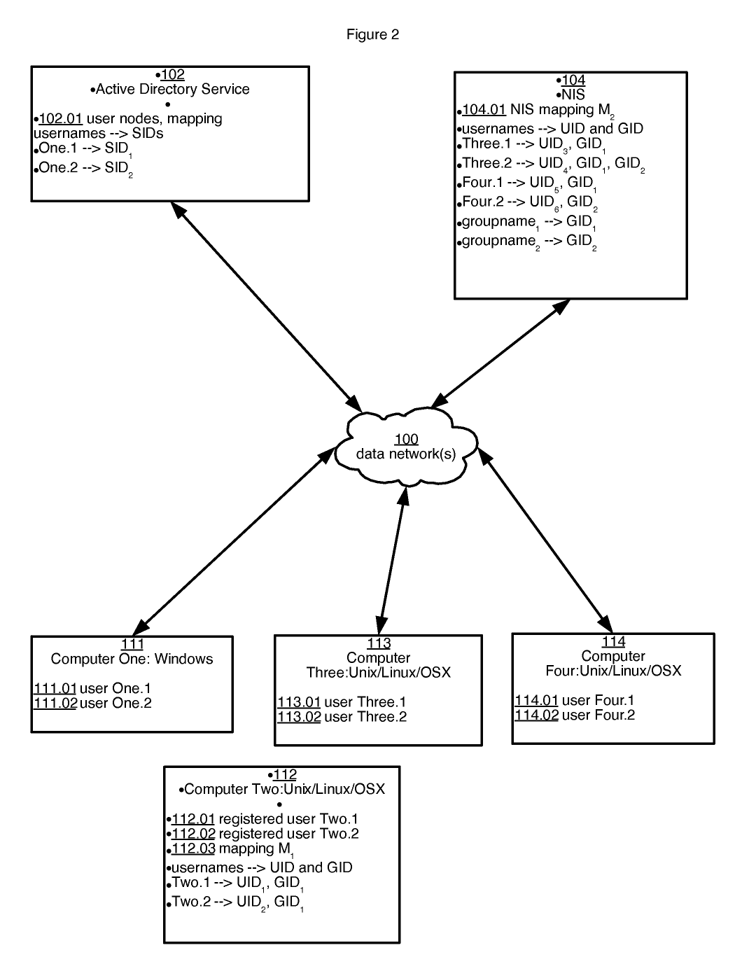

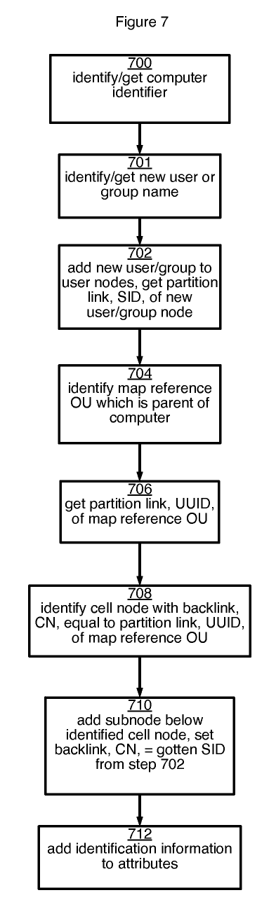

FIG. 2 is a functional block diagram of exemplary computing devices and some data structures and/or components thereof, wherein a DS which supports AD has not yet been modified according to this disclosure. FIG. 2 depicts one or more data networks 100, through which a plurality of computers communicate. The computers may be provided by a structure such as the one shown in FIG. 7, discussed further below.

Computer One, 111, is a Windows computer comprising two users with usernames “One.1, 111.01, and “One2,” 111.02. The usernames depicted in this and other figures are not meant to be actual usernames (canonically correct or otherwise), merely examples used for convenience in this disclosure. Computer Two, 112, is a Unix/Linux and/or OSX computer comprising two registered users with usernames “Two.1, 112.01, and “Two.2,” 112.02, and mapping M₁ 112.03 which comprises entries mapping the user names to UID and GID numbers as shown. These users are referred to as “registered” because their credentials reside on Computer Two. Computer Three, 113, is a Unix/Linux and/or OSX computer comprising two users with usernames “Three.1, 113.01, and “Three.2,” 113.02. Computer Four, 114, is a Unix/Linux and/or OSX computer comprising two users with usernames “Four.1, 114.01, and “Four.2,” 114.02.

FIG. 2 further depicts NIS 104. NIS 104 maintains mapping M₂ 104.01 with credential mappings for the users and groups of Computer Three 112 and Computer Four 113. As depicted in the example, user Three.1 maps to UID₃ and GID₁, user Three.2 maps to UID₄ and GID₁ and GID₂, user Four.1 maps to UID₅ and GID₁, user Four.2 maps to UID₆ and GID₂, group groupname₁ maps to GID₁, and group groupname₂ maps to GID₂. FIG. 2 further depicts an AD server 102, which is further depicted as comprising user nodes 102.01 which map user One.1 to SID₁ and user One.2 to SID₂. Mappings of user names to SID's in the AD may be accomplished, for example, by assigning the common name of a user node 102.01 to be the user name of the user and the value of an attribute associated with the user object instance to contain the SID.

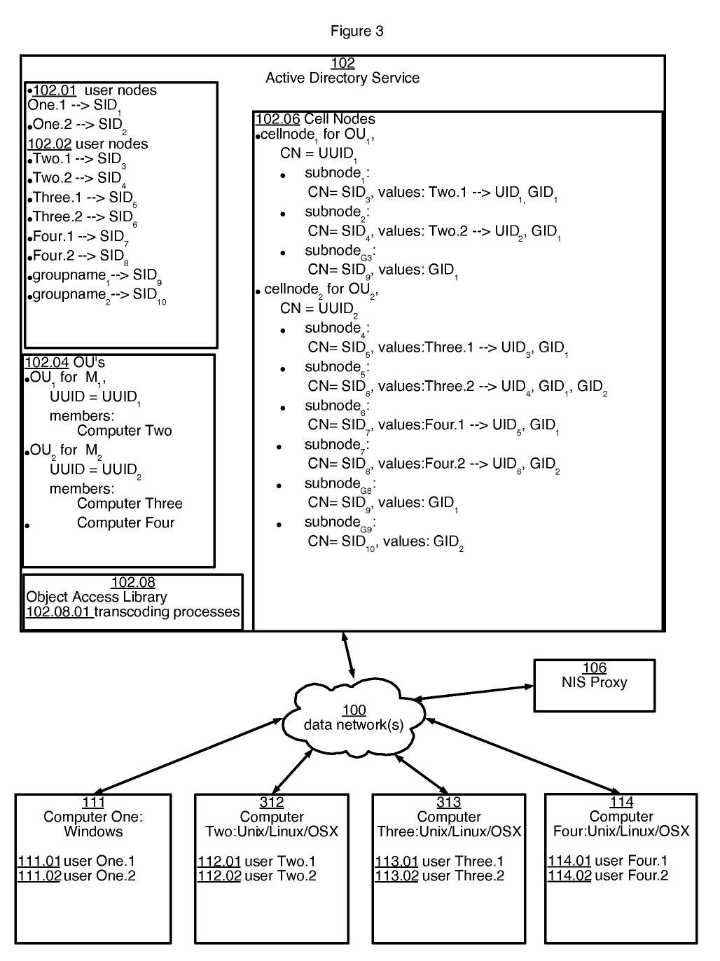

FIG. 3 is a functional block diagram of exemplary computing devices and some data structures and/or components thereof, wherein a DS which supports AD has been modified according to this disclosure. New features as compared to FIG. 2 comprise an NIS Proxy 106, which may be utilized by Computer Three 113 and Computer Four 114 and which may appear to these computers as the NIS 104 did previously. New features further comprise additional user and group nodes 102.02 in the AD server 102. The new user nodes 102.02 map user Two.1 to SID₃, user Two.2 to SID₄, user Three.1 to SID₅, user Three.2 to SID₆, user Four.1 to SID₇, user Four.2 to SID₈, and groups groupname₁ to SID₉, and groupname₂ to SID₁₀. As above, the user and group names may be assigned to the common name for the additional user and group nodes 102.02. New features further comprise new and/or additional OU's 102.04: OU₁, created for mapping M₁ and OU₂ created for mapping M₂ (creation of these OU's is discussed further below). These OU's 102.04 are depicted as comprising a UUID, UUID₁ for OU₁, and UUID₂ for OU₂. These OU's 102.04 are further depicted as comprising members, which may be represented by child nodes below these OU's in the LDAP structure; the members of OU₁, are depicted as comprising Computer Two while the members of OU₂ are depicted as comprising Computer Three and Computer Four. It should be noted that sequential numbering of these features is for convenience and the purpose of example only and that the values do not necessarily have to be different, the same, nor that values even need be present. It should also be noted that “UUID” stands for “Universally Unique Identifier” and should generally be understood in this disclosure to be synonymous with “GUID” or “Globally Unique Identifier.” It should also be noted that “UUID” and “common name” or “CN” may be referred to herein without necessarily being identified as an attribute.

New features of the AD server 102 further comprise Cell Nodes 102.06. These Cell Nodes 102.06 are depicted as comprising cellnode₁ and cellnode₂; the common name (“CN”) for cellnode₁ is shown as UUID₁ while the common name for cellnode₂ is shown as UUID₂. Cellnode₁ is depicted as having the following child nodes below it: subnode₁ with a CN of SID₃ and attribute values comprising UID₁ and GID₁, subnode₂ with a CN of SID₄ and attribute values comprising UID₂ and GID₁, and subnode_{G3} with a CN of SID₉ and attribute values comprising GID₁. Cellnode₂ is depicted as having the following child nodes below it: subnode₄ with a CN of SID₅ and attribute values comprising UID₃ and GID₁; subnode₅ with a CN of SID₆ and attribute values comprising UID₄ and GID₁ and GID₂; subnode₆ with a CN of SID₇ and attribute values comprising UID₅ and GID₁; subnode₇ with a CN of SID₈ and attribute values comprising UID₆ and GID₂; subnode_{G8} with a CN of SID₉ and attribute values comprising GID₁; and subnode_{G9} with a CN of SID₁₀ and attribute values comprising GID₂.

Certain of the subnodes are depicted with a single subscript numeral while other of the subnodes are depicted with a subscript preceded by the letter “G.” The numbering of these features is for the sake of convenience only; the “G” is meant to be a reminder in this description only that these subnodes carry information for a group. Certain of the attribute value entries in the drawing are preceded by marks such as “Two.1-->” before the value entries. These marks may or may not be present in actual value entries or may be present in a different form, as discussed further below in relation to “pseudo-values.” Not all of the features of the object instances depicted in FIG. 3 are shown for all of the object instances; for example, OU's 102.04 are depicted as comprising an UUID while the Cell Nodes 102.06 are depicted as comprising a CN but not a UUID (the CN is set to a value which is the same as the UUID for another node, such as UUID₁ for cellnode₁). In an actual implementation, the OU's may further comprise a CN and the Cell Nodes may further comprise a UUID. Furthermore, the cell nodes may be located below other child nodes intermediate between the Cell Nodes 102.06 and the “Program Data” node in the Application Partition. For example, a sample of the hierarchical directory structure may appear as follows:

CN=Program Data

CN=Centeris

CN=Likewise

CN=Cells

CN=<uuid of OU₁>

CN=<uuid of user₁>
CN=<uuid of user₂>
...
CN=<uuid of userₙ>
CN=<uuid of group₁>
CN=<uuid of group₂>
...
CN=<uuid of groupₙ>

CN=<uuid of OU₂>
...
CN=<uuid of OUₙ>
...

As noted above, the Application Partition may exist in a discrete location within the DS heirarchy, as depicted above, or the Application Partition may comprise multiple branches and/or specific leaf nodes which are present throughout the DS tree structure.

Also depicted in FIG. 3 is an Object Access Library (“OAL”) 102.08, which comprises transcoding processes 102.08.01. The OAL is a software component that returns a software data structure that combines the data found in one or more DS object instances with “Additional Data” (which may be any new data) found in an associated object instance in the Application Partition. The transcoding processes 102.08.01 comprise instructions for transcoding data into a format compatible with an attribute, potentially including the addition of a prefix, suffix, or other label to the transcoded data. For example, data may contain a 32-bit binary value which is meant to be a GID number (a group identifier for a Unix computer); the transcoding processes 102.08.01 may convert the data comprising the GID number into an ASCII string comprising “gidNumber=xxxxxx.” The ASCII string may then be stored as a value in an attribute which has an ASCII string data type. “gidNumber=xxxxxx” may not be customary value for the attribute and the attribute may not customarily be a container for GID numbers; nonetheless the attribute may be compatible with this value, such as a “description” attribute which may contain alphanumeric strings. The transcoding processes 102.08.01 may then further comprise instructions to parse “pseudo-value” attribute values and to perform reverse transcoding operations. For example, the transcoding processes 102.08.01, may parse the ASCII string attribute value comprising “gidNumber=xxxxxx;” the parser may identify “gidNumber=” in the attribute values and that this value is a condition which indicates that the following characters are a GID number; the mask may then remove this portion, leaving only “xxxxxx,” which ASCII value may then by type-converted into a 32-bit binary value. In this disclosure, a “pseudo-value” is an attribute value such as “gidNumber=xxxxxx” which is recognized by the Object Access Library 102.08 and/or by the transcoding processes 102.08.01 as a value which is to be or has been converted or transcoded, as described above.

The OAL 102.08 and/or the transcoding processes 102.08.01 may further be comprise instructions to search for corresponding backlinks and partition links (discussed further below), to obtain values from attributes associated with identified object instances, to perform reverse transcoding on obtained values, to combine obtained values (whether in a native format or following a reverse transcoding process) from one or more object instances, and to properly format the obtained and/or combined values as data and to return such data as one or more unified data structures.

The OAL 102.08 and the transcoding processes 102.08.01 may be provided by hard-coded instructions and/or by a table which comprises such instructions in the form of regular expressions or similar programming techniques. The transcoding and conversion of attribute values may be as simple as noting that a “fax number” attribute be handled as a “phone number” or as complex as a multi-stage compression algorithm; for performance reasons, the transcoding and conversion may be chosen to be computational efficient, such as a mask.

Also new in FIG. 3 is that Computer Two is now labeled 312. This is because the mappings which previously had been resident on Computer Two are now maintained by the AD 102, so the users of Computer Two are no longer referred to as “registered” users.

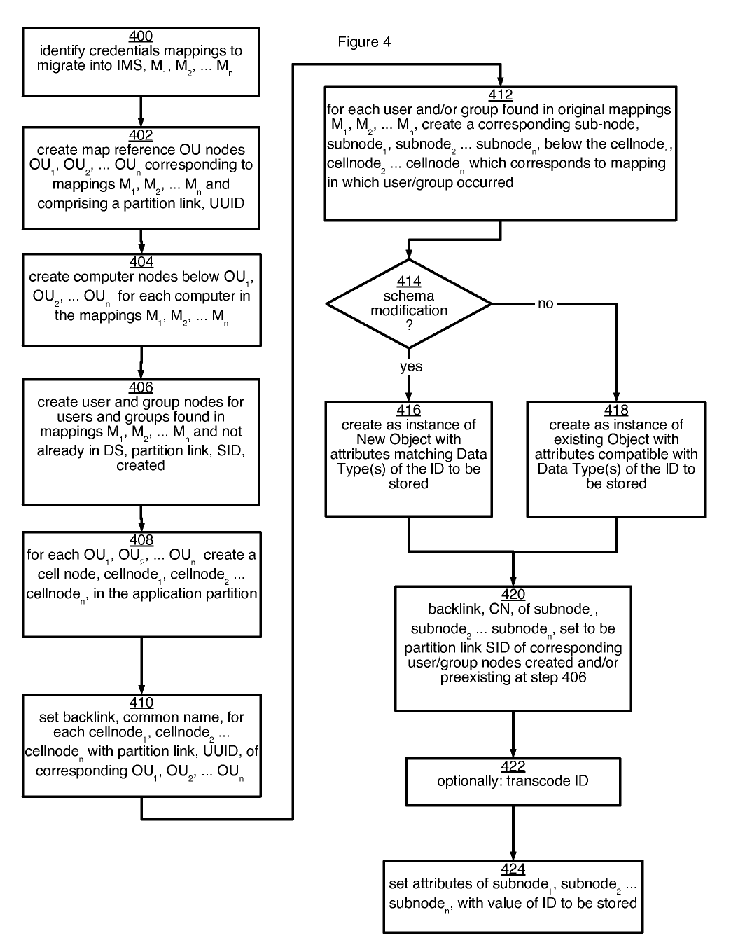

FIG. 4 is an operational flow diagram generally illustrating steps consistent with certain aspects of the invention, wherein mappings M₁, M₂ . . . Mₙ are migrated into a unified IMS, such as may be provided by an AD server 102. At step 400, the mappings M₁, M₂ . . . Mₙ are identified, such as by reviewing the mappings as present in NIS 104 and Computer Two 112. At step 402 map reference nodes OU₁, OU₂ . . . OUₙ are created; these OU's are meant to correspond to mappings M₁, M₂ . . . Mₙ which are to be migrated into the unified IMS. In FIG. 3, these are OU's 102.04. In this disclosure and for the sake of example, OU (“organization unit”) nodes are used to create the map reference nodes and are known to the OAL 108.02 and/or the transcoding processes 108.02.01 as such; however, in another embodiment, any other suitable node may be used for the reference nodes, provided that such reference node is capable of containing child computer nodes and provided the OAL 108.02 and/or the transcoding processes 108.02.01 are configured to recognize them as the map reference nodes. These OU's are not created in the Application Partition, but in the normal location within the DS where such nodes are placed. The map reference OU nodes comprise a “partition link.” In this disclosure and for the sake of example, the “partition link” for the map reference nodes is known to the OAL 108.02 and/or the transcoding processes 108.02.01 to be the UUID attribute of such nodes. Another attribute value may be used by the OAL 108.02 and/or the transcoding processes 108.02.01 as the partition link value instead without necessarily changing the function of the partition link value. In the example used in this disclosure, the partition link value for the map reference node OU₁ is UUID₁.

At step 404, computer nodes (instances of the computer object class) are created as child nodes below the created map reference OU's, one computer node for each computer which utilizes the mapping to which the parent map reference OU corresponds. For example, in FIG. 3, OU₁ has a child computer node for Computer Two while OU₂ has two child computer nodes for Computers Three and Four (depicted in FIG. 3 as being “members” of the corresponding OU).

At step 406, user and group nodes are created for users and groups found in mappings M₁, M₂ . . . Mₙ and which are not already in the DS which supports the IMS. The created user and group nodes are depicted in FIG. 3 as user nodes 102.02. Users and groups found in the mappings M₁, M₂ . . . Mₙ and which already have a user or group node in the DS supporting the IMS do not have to have a new user or group node created for such pre-existing users and/or groups. It should be noted that the SID values (“SID” plus a subscript number) are not proper SID values, nor are other values depicted in the figures meant to be properly formatted values for such attributes. All user and group nodes (pre-existing or created at step 406) have a SID attribute which is assigned a SID value by the DS which supports the IMS, such as the SIDs shown in FIG. 3 which are associated with user nodes 102.01 and user nodes 102.02. In this disclosure, and for the purposes of example, the “partition link” for these user and group nodes (both created 102.02 and pre-existing 102.01) is known to the OAL 108.02 and/or the transcoding processes 108.02.01 to be the SID attribute of such nodes. Another attribute value may be used by the OAL 108.02 and/or the transcoding processes 108.02.01 as the partition link value for these nodes instead without necessarily changing the function of the partition link value. In the example used in this disclosure, the partition link value for the user node One.1 is SID₁, while the partition link value for the group node groupname₁ is SID₉.

At step 408, for each map reference OU, OU₁, OU₂ . . . OUₙ, created at step 402, a Cell Node, cellnode₁, cellnode₂ . . . cellnodeₙ, is created in the Application Partition. These are represented in FIG. 3 as Cell Nodes 102.06. At step 410 each cellnode₁, cellnode₂ . . . cellnodeₙ, is given a “backlink attribute” value, here, the common name (“CN”) attribute, which is the same as the partition link, which, above, was defined to be the UUID, of the map reference OU to which the cellnode corresponds. For example, FIG. 3 depicts cellnode₁ as having a common name equal to UUID₁, which is the UUID for OU₁. The common name, UUID₁, of cellnode₁ is the backlink of cellnode₁. Much as above, the backlink is an attribute of an object instance in the Application Partition which is known to the OAL 210.12 and/or the transcoding process 210.12.01 to be a backlink; in this disclosure, the backlink attribute may be the common name attribute, though in another embodiment a different attribute may be used as the backlink without necessarily changing the function of the backlink. “Backlink” and “common name” may be used interchangeably in this disclosure when the value of the “common name” attribute is equal to the value of a partition link.

At step 412, for each user and/or group found in the mappings, M₁, M₂ . . . Mₙ, create a subnode below a cell node, which cell node corresponds to the map reference OU created at step 402 and which created map reference OU, in turn, corresponds to the mapping in which the user and/or group occurred. For example, FIG. 3 depicts subnode₁, subnode₂, and subnode_{G3} below cellnode₁. Cellnode₁ corresponds to OU₁; subnode₁ corresponds to user Two.1 112.01; subnode_{G3} corresponds to the group with GID₁ and groupname₁. It should be noted that groups are shown to overlap between mappings M₁ and M₂ though an overlap between users has not been shown; overlapping users may be treated similarly, such as if user Two.1 (present in mapping M₁) was also a registered user on Computer 4 (present in mapping M₂), then user Two.1 would receive only one user node in user nodes 102.02, and a subnode below cellnode₁, which corresponds to OU₁ and M₁, and a subnode below cellnode₂, which corresponds to OU₂ and M₂.

At step 414 a decision junction is depicted in which it is decided or determined whether or not the schema for the DS which supports the IMS may be modified. As noted above, a schema modification may occur when a new object class is added to a schema or when the attribute set of an existing object class is modified. The schema is not necessarily modified at step 414, but may have been modified previously. If schema modification is allowed or required, then the subnode created at step 412 is created as an instance of the new object class provided or identified at step 414; which new object class has attribute(s) which match or are at least compatible with the data type of the identifier which is to be stored as one or more values in the attribute(s). If schema modification is not allowed, then the subnode created at step 412 is created as an instance of an existing object class; which existing object class has attribute(s) which match or are at least compatible with the data type of the identifier which is to be stored as one or more values in the attribute(s).

At step 420, the subnode created between steps 412 and 418 is given a backlink attribute value, utilizing the common name attribute to be the backlink, per above, which is the same as the partition link value—per above, the value of the SID attribute—for the user and/or group created and/or preexisting at step 406. For example, FIG. 3 depicts subnode₁ (which holds data for user Two.1) as being assigned the common name or backlink attribute value of the partition link value “SID₃;” subnode₂ (which holds data for user Two.2) as being assigned the common name or backlink attribute value of the partition link value “SID₄;” subnode_{G3} (which holds data associated with GID₁ and groupname₁) as being assigned the backlink attribute value “SID₉.” It should be noted that subnode_{G8} which is a child node below cellnode₂, may also be assigned the common name or backlink attribute “SID₉.”

At step 422, the identification data is optionally transcoded into the data type of the attributes of the object instance created between steps 412 and 420. Such encoding may be performed by the OAL 102.08 and the transcoding processes 102.08.01. The identification data may then be embodied in a pseudo-value. At step 424, the attributes of the subnode created between steps 412 and 420 are set to contain the value(s) of the identification information, as is shown in FIG. 3. Setting the value(s) of the attributes may be performed by the OAL 102.08 and the transcoding processes 102.08.01, as discussed above.

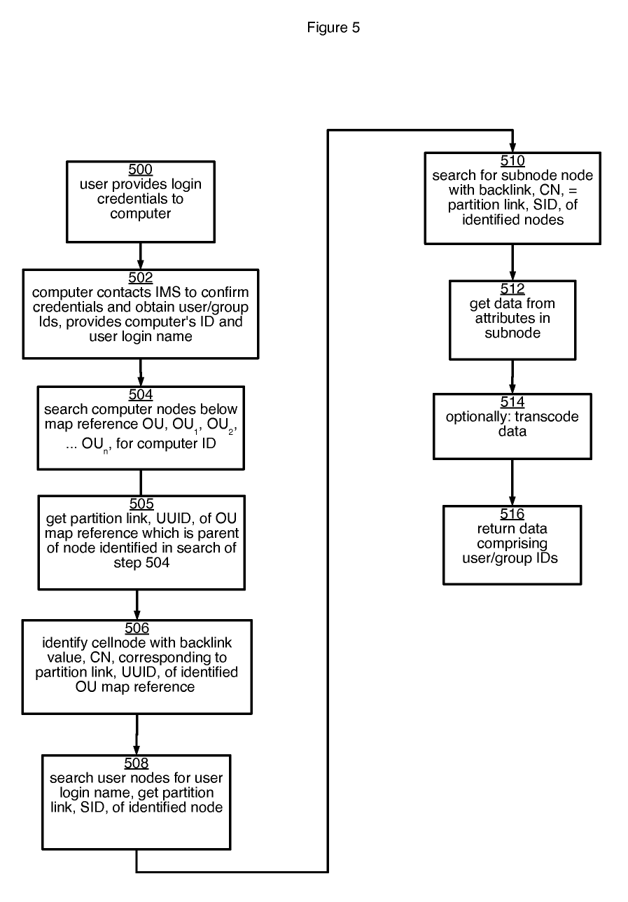

FIG. 5 is an operational flow diagram generally illustrating steps consistent with certain aspects of the invention, wherein a unified IMS which has been modified according to the process described in FIG. 4 is utilized to confirm the credentials of a user. At step 500, a user provides credentials to a computer in which the user is logging in, such as Computer Four 114. At step 502, the computer contacts the IMS to obtain the user and group identifiers associated with the user and, optionally, to confirm the user's login credentials. The call comprising the contact may be routed by a NIS proxy 106. As part of step 502, the computer provides an identifier associated with the computer, such as a computer number or other identifier. At an optional step, not shown, a Kerberos server or an equivalent service may be utilized to confirm the login credentials.

At step 504, the computer nodes below the map reference OU's, including OU's 102.04 are searched for the identifier associated with the computer. The identifier associated with the computer may be an attribute value of a computer node, such as a common name. At step 505, the partition link, defined above to be the UUID, of the OU which is the parent of the node identified in step 504 is obtained. In the case of the example of Computer Four 114, OU₂ would be identified as the parent node of the computer node for Computer Four and UUID₂ would be returned in step 505. At step 506, the cellnode with a backlink attribute value—defined above to be the common name—equal to the partition link value, the UUID, returned in step 505 is identified, such as through a search, navigation, or equivalent operation in the DS which supports the IMS. In the case of the example of Computer Four, cellnode₂ would be found to have a backlink attribute or CN value equal to UUID₂.

At step 508, the user nodes, which in FIG. 3 are user nodes 102.01 and user nodes 102.02 are searched for the user login name provided as part of the login credentials provided by the computer at step 502. Also depicted as part of step 508, the partition link value—defined above to be the SID value—for the user node identified in the search is obtained. In the case of the example of Computer Four and registered user Four.1 114.01, the partition link value would be SID₇. At step 510 the subnodes below the cellnode identified in step 506 are searched for a subnode which has a backlink attribute value, or common name, equal to the partition link, or SID, identified in step 508. In the case of the example of Computer Four and registered user Four.1 114.01, the subnode with a common name equal to SID₇ is subnode₆. At step 512, the data in the values associated with the attributes of the subnode are obtained. At step 514, the values obtained at step 512 are optionally transcoded to match the data type which may be required to respond to the call which occurred at step 502 and according to the OAL 102.08 and the transcoding processes 102.08.01, discussed above. Step 516 depicts returning the data comprising the user and group identifiers which are found in the attributes of the identified subnode. In the case of the example of Computer Four and registered user Four.1 114.01, the values would be UID₅ and GID₁.

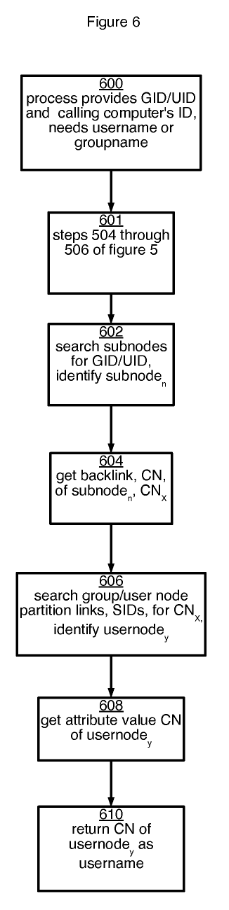

FIG. 6 is an operational flow diagram generally illustrating steps consistent with certain aspects of the invention, wherein a process provides a GID or UID and needs to obtain from the IMS a group or user name which corresponded to the GID or UID in a mapping which was migrated into the IMS. At step 600, a process provides a GUI and/or a UID in a call to the IMS (such a call may be routed by a NIS proxy 106). The call will also contain the computer's identifier. At step 601, steps 504, 505 and 506 from FIG. 5 are performed. At step 602, the subnodes below the cellnode identified at step 506 (within step 601) in the Cell Nodes 102.06 are searched to identify one or more subnode(s) which has a value equal to the GID or UID provided in the call of step 600. Generically, such subnode may be subnodeₙ. At step 604, the backlink, or common name, for subnodeₙ is obtained, designated here as CNₓ. At step 606, the group and user nodes 102.01 and 102.02 are searched for a group or user node which has a partition link value, or SID value, equal to the common name CNₓ, identifying, for example, usernode_{y}. At step 608, the common name for usernode_{y} is obtained. It may be recalled at this step that the user nodes 102.01 and 102.02 may have common names which are equal to user names. At step 610, the common name for usernode_{y} is returned as the user name requested in the call at step 600.

FIG. 7 is an operational flow diagram generally illustrating steps consistent with certain aspects of the invention, wherein a new user or group is added to a Unix, Linux, or similar computer and corresponding changes are made to a unified IMS. At step 700, a system administrator and/or the computer to which the user or group is to be added or another party or process contacts the IMS and provides the identifier of the computer to which the new user or group is to be added. At step 701, the new user name or group name is identified, supplied, or gotten. At step 702, a new user or group node is created in the user nodes. The newly created user or group node may be created in any available area in the DS for user nodes, such as in the area of user nodes 102.1 or 102.2 (which may, in any event, be in the same area of the DS hierarchy). The partition link, or SID, for the newly created user or group node may be obtained at this step. At step 704, the computer identifier from step 700 is used, for example in a search and/or tree navigation operation, to identify the map reference OU of which the computer is a member (as discussed above, the computer will have a node below one of the OU's 102.04). At step 706, the partition link value, or UUID, of the map reference OU identified in step 704 is obtained. At step 708, the cell node with the backlink value, or CN, equal (or equivalent to) the partition link value, or UUID, of the identified map reference OU obtained in step 704 is identified. At step 710, a subnode is created below the cell node identified in step 708. The backlink value, or CN, of the created subnode is set to be equal (or equivalent) to the partition link value, or SID, obtained in step 702. At step 712, the identification information, such as GID and/or UID numbers are added as values to one or more of the attributes of the created subnode. The identification information may be transcoded, as discussed above, prior to being added to the attribute value(s).

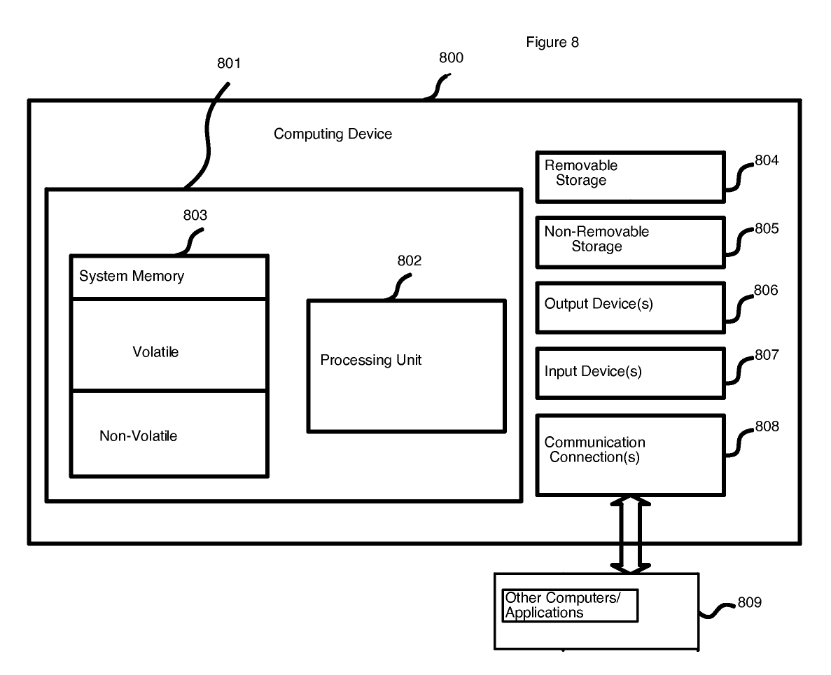

FIG. 8 is a functional block diagram of an exemplary computing device 800 that may be used to implement one or more computers described above. The computing device 800, in one basic configuration, comprises at least a processor 802 and memory 803. Depending on the exact configuration and type of computing device, memory 803 may be volatile (such as RAM), non-volatile (such as ROM, flash memory, etc.) or some combination of the two.

Computing device 800 includes one or more communication connections 808 that allow computing device 800 to communicate with one or more computers and/or applications 809. Device 800 may also have input device(s) 807 such as a keyboard, mouse, digitizer or other touch-input device, voice input device, etc. Output device(s) 806 such as a monitor, speakers, printer, PDA, mobile phone, and other types of digital display devices may also be included. These devices are well known in the art and need not be discussed at length here.

Additionally, device 800 may also have other features and functionality. For example, device 600 may also include additional storage (removable 804 and/or non-removable 805) including, but not limited to, magnetic or optical disks or tape. Computer storage media includes volatile and nonvolatile, removable and non-removable media implemented in any method or technology for storage of information such as computer readable instructions, data structures, program modules or other data. Memory 803, removable storage 804 and non-removable storage 805 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 800. Any such computer storage media may be part of device 800.

1: A method of migrating credentials in a directory service, the directory service comprising a schema and an application partition, the method comprising the following steps:
identifying credential mapping(s) to migrate into the directory service;
creating an map reference node(s) for each mapping to migrate into the directory service, which created map reference node comprises a partition link;
for each created map reference node, creating a computer node below such created map reference node, one for each computer which appears in the credential mapping which corresponds to the created map reference node;
for each user and/or group found in a credential mapping which user and/or group does not already have a user or group node in the directory service, creating a user or group node comprising an attribute which is a partition link;
for each created map reference node, creating a corresponding cell node in the application partition;
setting the backlink attribute for each created corresponding cell node to be the value of the partition link of the map reference node to which the cell node corresponds;
for each user and/or group in the credential mapping(s), creating a subnode below the cell node which corresponds to the map reference node which was created for the mapping in which the user and/or group occurred, which created subnode comprises a backlink attribute;
for each created subnode, setting the backlink attribute to be the same as or equivalent to the partition link of a corresponding created or pre-existing user and/or group node;
setting at least one attribute of a created subnode with the value of or equivalent to a credential identifier.

2: The method according to claim 1, where the created map reference node is an OU node.

3: The method according to claim 1, where the partition link attribute for a created user or group node is a SID attribute.

4: The method according to claim 1, where the partition link attribute for a created map reference node is a UUID attribute.

5: The method according to claim 1 where the backlink attribute is the common name attribute.

6: The method according to claim 1, where the directory service further comprises an object access library and further comprising a step of transcoding a credential identifier into a pseudo-value.

7: The method according to claim 1, where the directory service further comprises an object access library and further comprising a backlink attribute value which is a pseudo-value.

8: The method according to claim 1, where the directory service further comprises an object access library and further comprising a partition link attribute value which is a pseudo-value.

9: A computer readable medium comprising thereon instructions which, when executed, perform steps according to the method of claim 1.

10: A method of obtaining user and/or group identifiers from a directory service, the directory service comprising a schema and an application partition, the method comprising the following steps:
receiving a computer identifier and a user's login name;
searching computer nodes in the directory service for a computer node including an attribute value equal and/or equivalent to the received computer identifier and getting the partition link value of the map reference node which is the parent node of the computer node identified in the search;
searching cell nodes for a cell node with a backlink attribute value which is equal or equivalent to the partition link value of the map reference node;
searching user nodes in the directory service for the received user login name and getting the partition link of the user node identified in the search;
searching subnodes for a backlink attribute value which is equal or equivalent to the partition link of the user node;
getting data comprising user and/or group credential identifier(s) from the values in the attributes in a subnode.

11: The method according to claim 10, where the map reference node is an OU node.

12: The method according to claim 10, where the partition link attribute for a user or group node is a SID attribute.

13: The method according to claim 10, where the partition link attribute for an map reference is a UUID attribute.

14: The method according to claim 10 where the backlink attribute is the common name attribute.

15: The method according to claim 10, where the directory service further comprises an object access library and further comprising transcoding a credential identifier from a pseudo-value.

16: The method according to claim 10, where the directory service further comprises an object access library and further comprising a backlink attribute value which is a pseudo-value.

17: The method according to claim 10, where the directory service further comprises an object access library and further comprising a partition link attribute value which is a pseudo-value.

18: A computer readable medium comprising thereon instructions which, when executed, perform steps according to the method of claim 10.

19: A method of obtaining a username or a groupname from a directory service, the directory service comprising a schema and an application partition, the method comprising the following steps:
receiving a GID or a UID in a call;
searching subnodes for a received GID or UID and identifying a subnode;
getting the backlink value of the identified subnode;
searching group and user nodes for a partition link equal or equivalent to the gotten backlink attribute and identifying a group or user node;
getting an attribute value from the identified group or user node, which attribute value contains a username or group name.

20: The method according to claim 19 where the attribute from the attribute value from the identified group or user node is the common name attribute of the identified group or user node.

21: A computer readable medium comprising thereon instructions which, when executed, perform steps according to the method of claim 19.

22: A method of adding a group or user and corresponding group and/or user credentials and/or identifiers to a directory service, when the group or user is a group or user of a Unix or Linux computer, comprising the following steps:
obtaining an identifier of the computer which is to be a resource for the group or user;
obtaining the user name or group name of the group or user to be added;
adding a new user or group node to the user and/or group nodes of the directory service;
setting and/or obtaining the partition link value of the added new user or group node;
identifying the map reference node which is the parent of the computer node, which computer node includes an attribute associated with an identifier of the computer which is to be the resource for the group or user;
obtaining the partition link value of the identified map reference node;
identifying a cell node with a backlink value equal or equivalent to the obtained partition link value of the identified map reference node;
creating a subnode below the identified cell node;
setting the backlink of the created subnode to be equal or equivalent to the set and/or obtained partition link value of the added user and/or group node;
adding the group and/or user credentials and/or identifiers as values to one or more attributes of the created subnode.

23: The method according to claim 22 where a partition link value is a value from a SID attribute.

24: The method according to claim 22 where a partition link value is a value from a UUID attribute.

25: The method according to claim 22 where a map reference node is an OU node.

26: The method according to claim 22 where a backlink value is a value from a common name attribute.

27: A computer system to provide a credential mapping service comprising the following components:
a memory structure configured to store object instances;
a directory service component comprising a schema of object classes and an object access library component, wherein the directory service component further comprises instructions which, when executed:
identify credential mapping(s) to migrate into the directory service;
create an map reference nodes for each mapping to migrate into the directory service, which created map reference node comprises a partition link;
for each created map reference node, create a computer node below such created map reference node, one for each computer which appears in the credential mapping which corresponds to the created map reference node;
for each user and/or group found in a credential mapping which user and/or group does not already have a user or group node in the directory service, create a user or group node comprising an attribute which is a partition link;
for each created map reference node, create a corresponding cell node in the application partition;
set the backlink attribute for each created corresponding cell node to be the value of the partition link of the map reference node to which the cell node corresponds;
for each user and/or group in the credential mapping(s), create a subnode below the cell node which corresponds to the map reference node which was created for the mapping in which the user and/or group occurred, which created subnode comprises a backlink attribute;
for each created subnode, set the backlink attribute to be the same as or equivalent to the partition link of a corresponding created or pre-existing user and/or group node;
set at least one attribute of a created subnode with the value of or equivalent to a credential identifier;
receive a computer identifier and a user's login name;
search computer nodes in the directory service for a computer node including an attribute value equal and/or equivalent to the received computer identifier and get the partition link value of the map reference node which is the parent node of the computer node identified in the search;
search cell nodes for a cell node with a backlink attribute value which is equal or equivalent to the partition link value of the map reference node;
search user nodes in the directory service for the received user login name and get the partition link of the user node identified in the search;
search subnodes for a backlink attribute value which is equal or equivalent to the partition link of the user node;
get data comprising user and/or group credential identifier(s) from the values in the attributes in a subnode.

28: The system according to claim 27, wherein the object access library further comprises instructions comprising transcoding processes which, when executed, transcode data to be added into a pseudo-value and/or transcode a user and/or group identifier out of a pseudo-value.

29: The system according to claim 27, wherein the object access library further comprises instructions which, when executed, determine if there is no object instance outside of the application partition which has a partition link value which is the same as the backlink of the first object instance, and, if so, then labels the first object instance as an orphaned object instance.
